(19) United States
(12) Patent Application Publication
(10) Pub. No.: US 2015/0045100 A1
(43) Pub. Date: Feb. 12, 2015

(54) SYSTEM AND METHOD FOR MANAGING A CARD GAME

(71) Applicant: Vinco Games Ltd., Tel Aviv (IL)

(72) Inventor: Yaniv ALAL, Tel Aviv (IL)

(21) Appl. No.: 14/455,087

(22) Filed: Aug. 8, 2014

Related U.S. Application Data
(60) Provisional application No. 61/863,475, filed on Aug. 8, 2013.

(51) Int. Cl. G07F 17/32

(52) U.S. Cl. CPC G07F 17/3227
USPC 463/11

(57) ABSTRACT

A system and method for managing a card game. A system and method may determining the number of participants in the game is above a threshold, receive blind bets from players, deal cards to players, receive commands from players, determine a winner; and update a balance of the winner. A system and method may include players in the game based on a criterion. A system and method may include obtaining information related to players from a social network and manage the game based on the information. A system and method may include determining to expose cards based on a rule.

### PRIOR APPLICATION DATA

The present application claims benefit from prior U.S. provisional application No. 61/863,475 filed on Aug. 8, 2013, incorporated by reference herein in its entirety.

### FIELD OF THE INVENTION

The present invention relates generally to online games. More specifically, the present invention relates to methods, devices and systems for managing an online card game.

### BACKGROUND

Online (e.g., via computer over a network such as the Internet) games are known in the art. For example, online games such as blackjack and poker are known. However, current systems and methods for online gaming rules do not enable users to define rules that govern the games. Moreover, known systems and methods do not enable a scoring system that takes into account information related to the actual players.

### SUMMARY

A system and method for managing a card game. A system and method may determining if or that the number of participants in the game is above a threshold, receive blind bets from players, deal cards to players, receive commands from players, determine a winner; and update a balance of the winner. A system and method may include players in the game based on a criterion. A system and method may include obtaining information related to players from a social network and manage the game based on the information. A system and method may include determining to expose cards based on a rule.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 is a flowchart of a method of managing a card game according to an embodiment of the present invention;

FIG. 2 is a block diagram of a system for managing a card game according to embodiments of the present invention; and

FIGS. 3 is an illustrative screen shot according to embodiments of the present invention;

FIGS. 4 is an illustrative screen shot according to embodiments of the present invention; and

FIGS. 5 is an illustrative screen shot according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

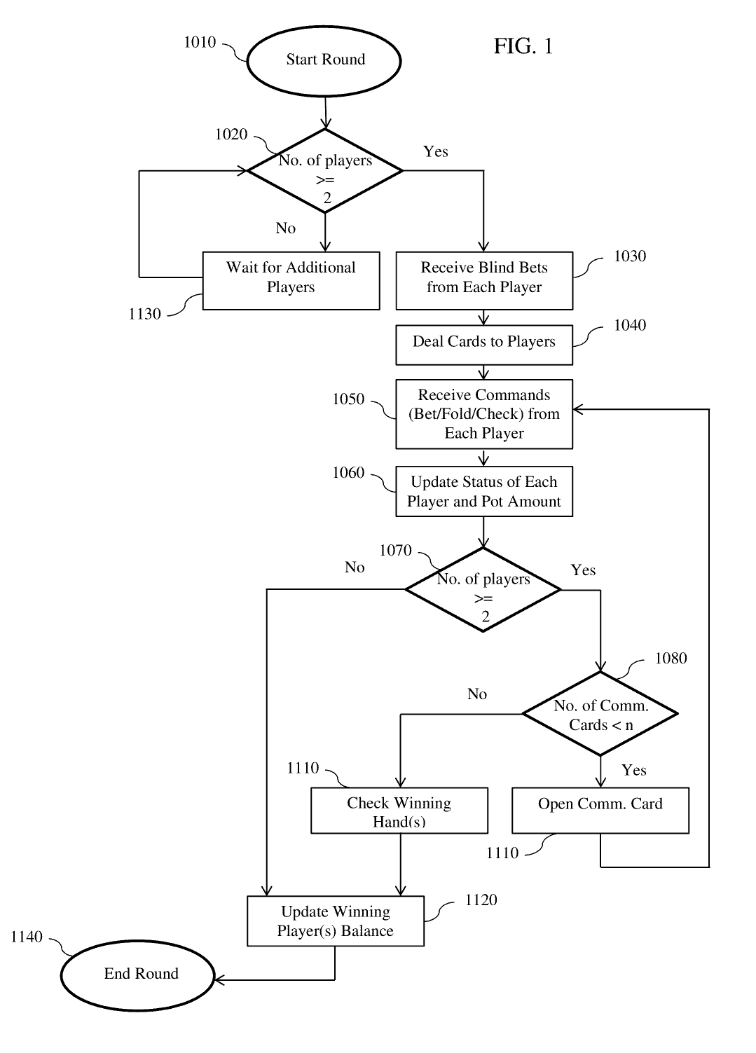

Reference is made to FIG. 1 which is a flowchart of a method of managing or operating a card game according to an embodiment of the present invention. A card game may as disclosed herein simulate a game played with playing cards, e.g., a standard 52 card deck or another type of card game with a different set of playing cards.

While the description below refers to a virtual card game, it should be appreciated that a system or method according to some embodiments of the present invention may manage, create, operate or display a real (physical) card game played around a real card table.

A player may join a game table by entering to an application installed on his or her non-dedicated computing device, such as a smart-phone, a tablet, a laptop or a desktop Personal Computer (PC), connected to a network (e.g., the Internet). Alternatively or additionally, a player may join a card game according to some embodiments of the present invention without installing an application onto his or her computing device, by entering a website.

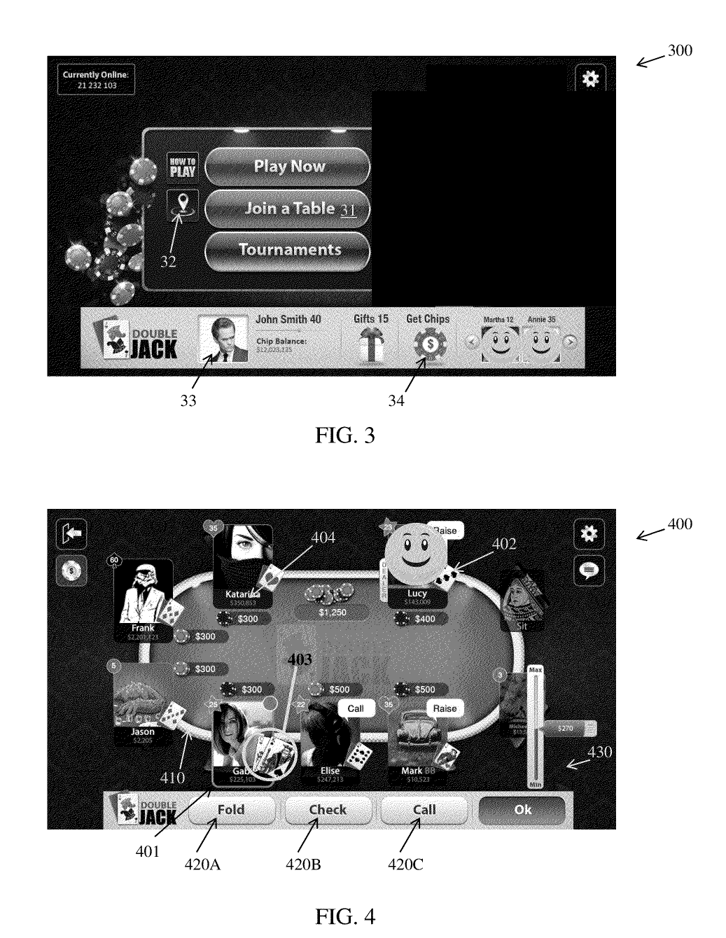

According to some embodiments of the present invention, when a player enters the application or website of the card game, an opening screen may be displayed allowing the player to select from a plurality of options. An exemplary opening screen is illustrated in FIG. 3 discussed herein.

A round of a game may be initiated when two or more players join a card game table by selecting the “Join a Table” button (31 in FIG. 3) or by a player inviting players to join a card game by pressing a game initiation button (32 in FIG. 3) [block 1010]. Any other manner of joining a game may be applied, as may be known in the art. For example, pressing button 31 may cause a processor to increase the number of players in a list related to a game and/or related to a round of a game.

When a card game is player initiated, the initiating player may set requirements or criteria for joining the game. For example, the initiating player may require that additional players be located within a defined radius from the initiating player or that the game be a location based game only allowing a player in a defined location to join the game. Accordingly a processor (e.g., controller or processor 211) may receive, from a user, requirements or criteria related to a game and may manage a game or round according to the requirements or criteria. Accordingly, a system and method may only include in the game players that meet a criterion received from a user.

For example, processor 211 may only enable players in a defined area (e.g., New York City or state of Texas) to participate in a game or round, as criteria.

According to other embodiments, only players that are associated with the initiating player (e.g., are indicated as friends of the initiating player in a social network such as the FaceBook™ network or the like) may join the game. For example, processor 211 may examine a FaceBook™ account of a user and only enable players who are “FaceBook™ friends” of the user to participate in a game or round. It will be understood that any other criteria may be defined and adhered to, for example, the skill of players, age, a residential address, a gender and the like may all be indicated by a user and used, e.g., by processor 211, in order to determine whether a user requesting to join (or participate in) a game or round will be enabled to do so.

As shown by block 1020, a system and method may include determining whether the number of players is at or above a threshold and may only enable a game or round to commence if the number of players is at or above the threshold. For example, in an embodiment, the threshold may be two (“2”) a game may only be started when at least two players have joined a card game table. For example, processor 211 may maintain a list of players and may examine the list in order to determine or input the number of players and relate to number to a preconfigured threshold.

As shown by block 1130, a system and method may determine that the number of players is below a threshold, (e.g., there are fewer than two players) and may wait for additional players to join the game or round.

A system and method may include recording details and status of each player in a game or round. For example, processor 211 may record player's information in memory 212. Processor 211 may prompt user to enter information or it may obtain data related to users in other ways. For example, processor 211 may access various sources (e.g., FaceBook™) and obtain information related to users (e.g., skill, age, gender, address etc.).

A system and method may include a status table (e.g., maintained by, and stored on game server 210) that may include any information related to players. A system and method may include assigning a playing position around a game table. For example, game server 210 may assign seats around a table to players.

A system and method may include managing credit or chips, or tokens representative of real or imagined monetary value, of a game. For example, in some embodiments, the status of a player may be initially set to be “participating” and the player's credit may be set to a predefined initial amount or to an amount personally set by (and received from) each player. For example, game server 210 may allocate to player one hundred chips upon joining a game. Alternatively or additionally, a player may purchase chips or may have a previous credit stored in the system from prior games. For example, using forms of payment known in the art, a user may interact with game server 210 and purchase chips.

When the game begins, game server may select one of the participating players as a dealer for the current round of the game.

Game server 210 may change the dealer for each new round of the game, e.g., according to a preset rule. For example, the first dealer may be selected randomly, by a processor 211 of the game server 210 and in each consecutive round of the game, the dealer is the player located in a playing position at the game table, which is next to the current dealer counterclockwise. As may be appreciated by those skilled in the art, other rules may be used in order to determine the identity of the dealer at each round. It would be further appreciated that, according to some embodiments, the dealer may be a computerized character not participating in the game as a player. For example, processor 211 may act as a house dealer. A dealer may or may not function to actually distribute cards, and may mark the beginning point of where cards are to be distributed and/or where from which bets are to start being received, or other functions.

As shown by block 1030, a system and method may include receiving bets. For example, processor 211 may receive bets from players. In an embodiment, prior to the cards being dealt to the participating players, some or all of the participating players may be required to place a blind bet.

According to some embodiments of the present invention, the sum of the blind bet may be different among different players and among different rounds of the game.

For example, according to one embodiment of the present invention, a first player located in a player position which is next to the dealer clockwise may be required to place a first amount as a blind bet (e.g, a big blind bet), a second player located next to the first player clockwise may place a blind bet in an amount of half of the big blind bet (e.g. a small blind bet). According to some embodiments, the remaining participating players may not be required to place blind bets. According to yet other embodiments, all participating players may be required to place a blind bet at each round of the game. The amount required as a blind bet may be determined (e.g., by processor 211) based on any criteria. For example, processor 211 may determine an amount required from a player based on user data, e.g., based on the skill, age or gender of the player (all or which may be obtained as described herein). A blind bet may be for example a forced or required bet. For example, a blind bet or “blind” may be bet or posted by for example a player or players to the left of the dealer in a flop-style poker game.

In order to place a blind bet, each player may send a command to game server 210 via the input device of each player's non-dedicated computing device. For example, by pressing a button on a touch screen of a tablet or smartphone, by clicking a mouse button or by any other device for inputting commands to a computing device known in the art.

After the blind bets have been placed, the amount in the pot may be altered or updated (e.g., by game serve 210). The amount may further be stored or recorded, e.g., in memory 212. The pot may be sum of money or credit that players waged during a round, single hand or game; a pot is typically the combined sum for all the players for each round, hand or game. Players bets including blinds are typically placed in and thus increase the pot.

As shown by block 1040, cards may be dealt to players by server 210. For example, after receiving the blind bets, game server 210 may deal cards to all participating players. According to some embodiments of the present invention, a predefined number of cards may be dealt to each player (e.g., two cards to each player). According to one embodiment, the cards may be dealt in pairs. According to another embodiment, a first card is dealt to all participating players, and then a second card is dealt to all participating players, and so on. It will be understood that game server 210 may deal cards according to any rule or method. For example, a user initiating a game (or the first player joining a game) may select a rule for dealing cards in the game. Dealing cards to players may include, for example, providing players with virtual representations of cards of a computer screen. A dealt card, and cards in general, may be displayed to a user or users on for example devices 220, 222, 223, etc.

According to some embodiments of the present invention, a first card may be dealt face down (unexposed) and only presented to the player to whom the face down card was dealt, and a second card may be dealt facing up (exposed) and thus presented to all players positioned around the same card table. Alternatively, both cards dealt to each player may be facing down and presented only the player to whom they were dealt. It will be understood that game server 210 may deal cards according to any rule or method. For example, a user initiating a game (or the first player joining a game) may select a rule that dictates which of the cards dealt are exposed to all users. For example, a first rule may be “expose all cards”, a second rule may be “never expose cards” and a third rule may be “only expose first card dealt”. Exposing cards may mean that the card's value (e.g., suit and rank) is displayed. In one embodiment unexposed cards look identical to each other, to represent the back of cards, which are typically identical, and the face or front of the card shows its value (e.g., suit and rank).

As shown by block 1050, game server 210 may receive commands or input from players. For example, after cards have been dealt to all participating players, each player in his turn may send his commands to the game server 210.

Commands received from players may indicate a move or action related to the game. For example, a command may be to “fold” as known in the art. Generally, a “fold” means the player is not interested in further participating in the current round of the game. A command may indicate the user whishes to place a bet or to check. When placing a bet, a player may be required (e.g., by game server 210) to indicate whether to call the bets of previous participating players and/or to raise the bet of previous players.

As shown by block 1060, a system and method may update a status of each player and a pot amount. For example, when a player folds, the player's status may be changed in the player status table or list to “folded” or “non-participating”. A status table or list may be maintained, by game serve 210 in memory 212. When a player places a bet, his account may be debited (e.g., by game serve 210) and the amount in the pot may be updated (e.g., by game serve 210) according to the bet placed. A status may be displayed to a user or users on for example devices 220, 222, 223, etc.

A system and method may check the number of players in a game at any point during a game or round. For example, in an embodiment, after receiving the commands of players as shown by block 1050, at the end of a round or at any other point, game server 210 may check whether or not at least two players are still in the game. For example, as shown by block 1070, game server 210 may check the number of remaining players and, as shown by block 1120, if only one player remains, game server 210 may update the winning (or last remaining) player's balance. For example, game server 210 may determine the winner of a game or round (e.g., by determining the last remaining player, by determining the player with the highest suit, or by other methods), and may transfer the amount accumulated in the pot during the round the winner's account. A player's account may be for example a representation of the amount of money or currency associated with the player.

If at least two players are still in the game after commands from players have been received (e.g., at least two players did not fold), a first community card may be opened and presented to all players as shown by block 1110. A community card is a card dealt face up (typically in the center of the table) and is shared by all players. A card dealt face up is dealt or displayed so that for example the suit (e.g., heart, club, etc.) and rank (e.g., ace, two, three . . . king) are visible. Other ways of differentiating playing cards, other than suit and rank, or other than the specific suits and ranks commonly used in playing cards, may be used. Cards may be displayed to a user or users on for example devices 220, 222, 223, etc.

A system or method may include prompting the remaining participating players to enter their commands (e.g., as described herein with respect to block 1050). As shown by blocks 1080, 1110 and 1050, a system and method may open community cards and receive commands from players until the number of open community cards reaches or is above a predefined threshold. For example, operations shown in blocks 1080, 1110 and 1050 may be repeated until only a single participating player remains or until a predefined number or threshold n of community cards have already been opened (for example, for n=3, three community cards have been opened already).

After a predefined number of community cards have been opened or dealt (and/or presented to all players), the cards of all participating players may be opened or revealed to all players. Players may then use their pocket cards (the cards dealt to each player) and the community cards to create the best hand possible and the winning hand or hands may be determined, e.g., by game server 210 and as shown by block 1110.

As referred to herein, a deck of cards consists of 52 cards. These cards are divided into four suits, with each suit having 13 ranks. As may be appreciated by one of ordinary skill in the art, there are four suits in a deck of playing cards: hearts, clubs, diamonds and spades. According to one embodiment of the present invention, the ranking of hands is not suit sensitive. That is, the suits are all of equal value.

For example, each suit may be associated with thirteen ranks: 2, 3, 4, 5, 6, 7, 8, 9, 10, Jack, Queen, King and Ace. For example, a system or method may associate the Ace card with a value of 1 or a value of 11, for example, according to input or selection received from players, e.g., the first player joining a game or by players at a beginning of each round.

Values or ranks associated with cards or groups of cards (e.g., the groups of hearts, clubs, diamonds and spades, cards with a value higher than 10 etc.) may be configurable, e.g., based on input from a user. In one configuration, all cards that are higher than 10 (Jack, Queen and King) may have the same value and may be assigned a value of 10. It would be appreciated that other values may be assigned to each card. Determining an outcome of a game or round may be performed by calculating the sum associated with cards of each player. Accordingly, a system and method may include associating a value with a group of cards and determining an outcome of the game based on the value associated with cards held by the players.

A hand as referred to herein may include or consist of a player's pocket cards and may further consist of or include one or more of the community cards. For example, if the predefined number of community cards is set to 3, and the number of cards dealt to each player may be 2, and a hand may consist of 1 to 5 cards. That is, one of the two cards dealt to a player or one of the community cards, or any combination of pocket cards and community cards available. The value of a hand may be the sum of all cards' ranks (or values) in the hand. As described, cards' ranks (or values) may be defined or set by game server 210.

The game server may enforce rules. For example, in one embodiment or configuration, the player whose hand has the highest ranking or cumulative value wins. In an embodiment, if there is a tie, then the player with the most cards used in order to reach that value wins. In an embodiment, if there is more than one player with equally ranked hands, the pot may be split equally between all winning hands. That is, the determination (e.g., by game server 210) of the winning hand or hands may be according to the value of the cards dealt to the player in combination with the value of the community cards which are used in order to reach the most valuable hand, and further in accordance with the number of cards used in order to reach the most valuable hand. Exemplary hand rankings are provided below (highest ranking to lowest ranking):

11+10+5+6+10=21+21=42 with 5 Cards

11+10+11+10=21+21=42 with 4 Cards

8+6+2+3+2=21=With 5 Cards

8+4+6+3=21=With 4 Cards

7+5+9=21=With 3 Cards

10+11=21=With 2 Cards

7+6+2+3+2=20=With 5 Cards

7+5+3+5=20=With 4 Cards

10+7+3=20=With 3 Cards

11+9=20=With 2 Cards

6+6+2+3+2=19=With 5 Cards

A system and method may exclude ranks or values of a hand. For example, in one embodiment, a hand value in the range between 22 and 41, or higher than 42, is an illegal hand value and thus may not be ranked.

When a winner or winners are determined and the pot is credited to the winner or winners, the round ends as shown by block 1140 and another round may start as shown by the arrow connecting blocks 1140 and 1010. In an embodiment, a game ends when all players but one have either left the game or lost all their chips.

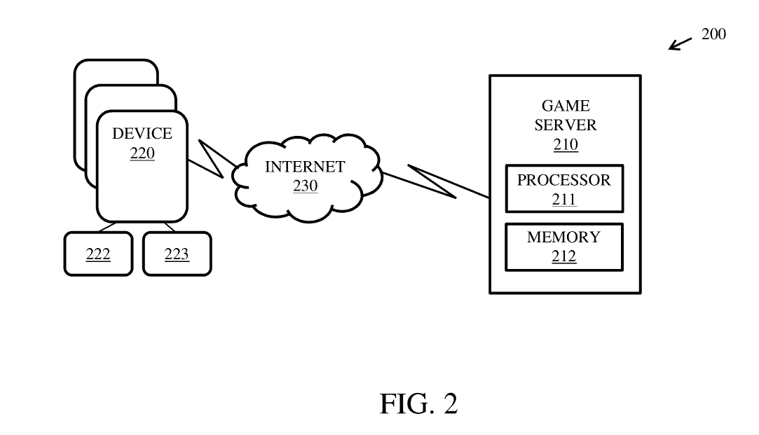

Reference is made to FIG. 2, which is a block diagram of a game system 200 for playing a card game according to an embodiment of the present invention. System 200 may include a game server 210 and one or more remote non-dedicated computing devices 220 in active communication with game server 210 via a network 230 that may be the Internet. Game server 210 may include a processor 211 and a memory 212. Processor 211 may be adapted to process inputs received from non-dedicated computing devices 220, read and write data to memory 212, and to provide information to one or more players' non-dedicated computing devices 220 via network 230. Memory 212 may be realized using any known non-transitory memory means. Controller or processor 211 may be configured to carry out embodiments of the present invention by for example executing instructions or software stored in memory 212 or other storage.

Non-dedicated computing devices 220 may include a processor (e.g., a processor similar to processor 211), input means 223, and output means 222. For example, a device 220 may include a display screen (that may be a touch screen), a keyboard, a mouse or any other input means known in the art. A display screen included in output means 222 may be adapted to present to the player a representation of a game table and/or other game information received from game server 210. Input means 223 may enable a player to participate in a game, e.g., by interacting with game server 210.

Some embodiments may be provided in a computer program product that may include a computer-readable storage medium (e.g., a memory similar to memory 212), having stored thereon instructions, which may be used to program a computer, controller or other programmable devices, to perform methods as disclosed above.

Embodiments of the invention may include an article such as a computer or processor non-transitory readable medium (e.g., a memory similar to memory 212), or a computer or processor non-transitory storage medium, including or storing instructions, e.g., computer-executable instructions, which when executed by a processor or controller (e.g., controller 211), carry out methods disclosed herein.

According to embodiments of the present invention, when a player wishes to join a game or initiate a game, the player may establish a communication channel between the players non-dedicated computing device 220 and game server 210, for example, by pressing an icon on screen 223, via network 230 and select a free position in a card game table presented on screen 223, or open a new card game table. When a round of the game begins, processor 211 may create a virtual visual representation of a card game table with an avatar of each player that is positioned at the table, and sends it to be displayed on screens 223 of non-dedicated computing devices 220 of the players. Processor 211 may randomly select one of the players to be a dealer, and a dealer indication may be then added next to the position of the dealer at the virtual card game table.

According to some embodiments of the present invention, bets may be placed by each player by pressing or clicking an icon or button on screen 223. When a command is received at server 210, the command may be processed by processor 211 and game information tables which may be stored in memory 212 may be updated according to the commands received. For example, when a player presses the fold button on screen 223 of his or her non-dedicated computing device 220, the command is received at server 210 via network 230 and processed by processor 211, and the status of the player is updated in a players status table from “participating” to “folded”. The updated status table may then be stored in memory 212. In another case or scenario, when a player places a bet, processor 211 may debit the player's account stored in memory 212, add the bet amount to the pot etc.

Reference is now made to FIGS. 3-5, which are exemplary screen shots according to some embodiments of the present invention. In an embodiment, game server 210 presents screens similar to the screenshots shown in FIGS. 3-5. Accordingly, players may interact with game server 210 using screens similar to the screens shown in FIGS. 3-5.

In FIG. 3, an exemplary opening screen 300 according to one embodiment of the present invention is presented. As shown, screen 300 enables a player to select between different features of the game, to receive information regarding his account and the like. For example, screen 300 may comprise a join a game button 31 to join a free table and may allow the initiation of a location based game by pressing button 32. As described, pressing any of the buttons shown in FIGS. 3-5 may cause sending a command and/or information to game server 210. According to some embodiments, screen 300 may present the players avatar 33, show a players balance and allow a player to purchase chips by pressing a get chips button 34. It would be appreciated by those skilled in the art that other or additional buttons and options may be available in opening screen 300.

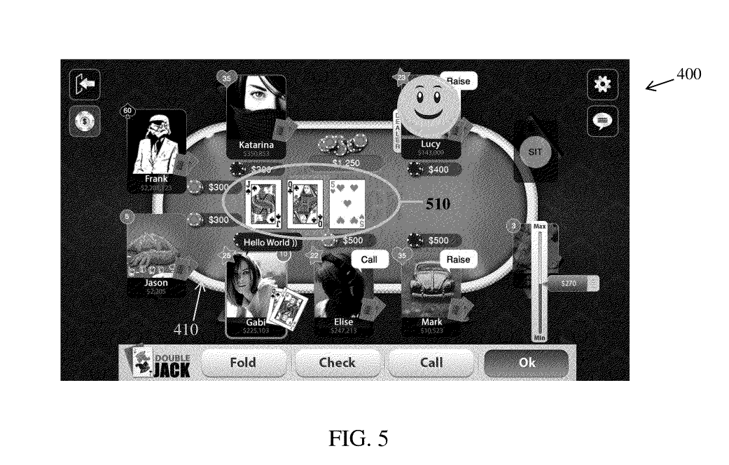

With reference to FIGS. 4 and 5, when joining a game table 410, a game table screen 400 may be presented on players' screens (e.g., 223). According to some embodiments, an avatar 401 of each player around table 410 may be presented next to the player's position around table 410. According to some embodiments, each player may also see the face of one card 402 of the other players pocket cards, and both of his or her pocket cards 403. According to some embodiments, a credit indicator 404 may be presented next to each player's location. Screen 400 may further comprise command buttons 420 such as a fold button 420A, a check button 420B, and a call button 420C. Screen 400 may further comprise a bet amount scale 430 to set a bet amount and place it. As may be further seen in FIG. 5, when community cards 510 are opened, community cards 510 may be presented to all players on the screens of their non-dedicated computing devices. It would be appreciated that other or additional buttons, icons and information may be presented to each player.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method of managing a card game, the method comprising:
determining a number of participants in the game is above a threshold;
receiving blind bets from players;
dealing cards to players;
receiving commands from at least some of the players;
updating status of at least some of the players;
determining a number of community cards is above a threshold;
determining a winner; and
updating a balance of the winner.

2. The method of claim 1, comprising including in the game only players that meet a criterion received from a user.

3. The method of claim 2, wherein the criterion is one of: a skill, an age, a residential address and gender.

4. The method of claim 1, including obtaining information related to players from a social network.

5. The method of claim 1, including determining an amount of a bet by a player based on information related to the player.

6. The method of claim 1, including determining to expose community cards based on a rule.

7. The method of claim 1, including updating a status of each player participating in the game and updating a pot amount at an end of a round of the game.

8. The method of claim 1, including updating a balance of a winner at an end of a round of the game.

9. The method of claim 1, including associating a ranking with a group of cards based on the value of the cards in the group and the number of cards in the group and determining a winner of a round based on the ranking.

10. The method of claim 9 wherein the group of cards is selected from the cards dealt to each one of the players and the community cards.

11. The method of claim 9, wherein the associating of ranking is based on user input.

12. An article comprising a computer-readable storage medium, having stored thereon instructions, that when executed by a controller, cause the controller to:
determine a number of participants in the game is above a threshold;
receive blind bets from players;
deal cards to players;
receive commands from at least some of the players;
update status of at least some of the players;
determine a number of community cards is above a threshold;
determine a winner; and
update a balance of the winner.

13. The article of claim 12, wherein the instructions when executed further result in including in the game only players that meet a criterion received from a user.

14. The article of claim 13, wherein the criterion is one of: a skill, an age, a residential address and gender.

15. The article of claim 12, wherein the instructions when executed further result in obtaining information related to players from a social network.

16. The article of claim 12, wherein the instructions when executed further result in determining to expose community cards based on a rule.

17. The article of claim 12, wherein the instructions when executed further cause the controller to update a status of each player participating in the game and updating a pot amount at an end of a round of the game.

18. The article of claim 12, wherein the instructions when executed further cause the controller to associate a ranking with a group of cards based on the value of the cards in the group and the number of cards in the group and to determine a winner of a round based on the ranking.

19. The article of claim 18 wherein the group of cards is selected from the cards dealt to each one of the players and the community cards.

20. A system comprising:
a memory; and
a processor configured to:
determine a number of participants in the game is above a threshold;
receive blind bets from players;
deal cards to players;
receive commands from at least some of the players;
update status of at least some of the players;
determine a number of community cards is above a threshold;
determine a winner; and
update a balance of the winner.
